(19) United States
(12) Patent Application Publication
(10) Pub. No.: US 2009/0248751 A1
(43) Pub. Date: Oct. 1, 2009

(54) Destroyable Instant Message (IM)

(76) Inventors: Darin M. Myman, Howell, NJ (US); Charles C. Watkins, Red Bank, NJ (US)

Correspondence Address: DIEHL SERVILLA LLC, 77 BRANT AVE, SUITE 210, CLARK, NJ, 07066, US

(21) Appl. No.: 12/060,406

(22) Filed: Apr. 1, 2008

(51) Int. Cl. G06F 17/30

(52) U.S. Cl. 707/200; 707/E17.009

(57) ABSTRACT

Systems and methods for processing instant messages by destroying them are disclosed. Setting a time for destroying a destroyable instant message is provided. Destruction of a message can be accompanied by visual effects. A destroyable instant message can be made not printable and not retrievable savable. Methods and systems for instant messaging using destroyable messages are also disclosed. Clients for instant messaging with destroyable instant messages are provided. A client for instant messaging with destroyable instant messages can be created with pre-installed applications, web page based applications and by using a plug-in to an existing instant messaging application.

### BACKGROUND OF THE INVENTION

The present invention relates to instant messages between two or more computing devices. More in particular it relates to destroyable messages in instant messages.

Instant messaging (IM) has become a very popular form of on-line communication for users of computing devices. IM allows users to almost instantaneously or real-time communicate with each other. Initially limited to computers, such as personal computers, IM is now possible from wired as well as wireless computing devices and from a wide range of computing devices including but not limited to phones, mobile phones, Personal Digital Devices (PDAs), GPS devices or any other computing device that can be connected to a network.

Instant messaging is commonly used for exchanging text messages. However, increasingly IM may involve exchange of multi-media content such as photographs, video, and sound. This content may for instance be captured with a mobile phone and sent via IM to a user.

The instant transfer of information to another party may pose in some cases a significant risk to the privacy of a user. Information may be transferred accidentally that was not intended to be transferred. A person may inadvertently have provided wrong information and would like to recall information. Some content may have been sent that on second thought would better not have been sent to a recipient.

It was shown in U.S. patent application Ser. No. 10/827,199, filed on Apr. 19, 2004, how email messages can be recalled and destroyed. IM currently has none of these capabilities.

Accordingly, novel and improved methods and apparatus providing improved privacy to IM users and enable the destruction of an instant message once it was sent are required.

### SUMMARY OF THE INVENTION

In accordance with one aspect of the present invention, a method for automatic destruction of an instant message in a computing device is provided. The method includes the steps of providing a capability in the computing device to destroy an instant message based on an instruction, receiving and detecting the instruction to destroy the instant message at the computing device and the computing device destroying the instant messaging based on detection of the instruction.

In accordance with another aspect of the present invention, the instruction includes a time after which the instant message will be destructed, wherein the computing device destroys the instant message in accordance with the time.

The instruction can be part of the instant message. It can also be a separate message. If it is separate, the instruction indicates which instant message is to be destroyed and how it is to be destroyed. Thus, the instruction can be sent to the computing device after the instant message was sent.

In accordance with a further embodiment of the present invention, the computing device is selected from the group consisting of: a computer, a mobile computing device, a mobile phone, and a GPS device.

The computing device can be connected to an Internet, wherein the instant message and the instruction are received via the Internet.

In accordance with a further aspect of the present invention, the method can be implemented by loading a plug-in to an existing instant messaging client for instant messaging on the computing device. The plug-in should be capable of destroying instant messages upon receipt of the instruction.

In accordance with another aspect of the present invention, the instant message cannot be printed. Further, the instant message also cannot be retrievably saved on the computing device in accordance with another aspect of the present invention.

Additionally, the present invention in a further embodiment provides for destroying a copy of the instant message on a sending computing device that transmitted the instant message by an instruction originating from the sending computing device.

### DESCRIPTION OF THE DRAWINGS

FIG. 1 illustrates a system in accordance with one aspect of the present invention;

FIG. 2 illustrates a destroyable instant message in accordance with an aspect of the present invention;

FIG. 3 illustrates examples of an instant messaging user interface in accordance with another aspect of the present invention;

FIG. 4 is a diagram of a client in a system in accordance with an aspect of the present invention;

FIG. 5 is a diagram of a client in a system in accordance with another aspect of the present invention;

FIG. 6 is a diagram of a client in a system in accordance with yet another aspect of the present invention;

FIG. 7 is a diagram of a client in a system in accordance with yet another aspect of the present invention;

FIG. 8 is a flow diagram of steps in accordance with an aspect of the present invention;

FIG. 9 is a flow diagram of steps in accordance with another aspect of the present invention;

FIG. 10 is a flow diagram of steps in accordance with yet another aspect of the present invention;

FIG. 11 is a flow diagram of steps in accordance with yet another aspect of the present invention; and

FIG. 12 is a flow diagram of steps in accordance with yet another aspect of the present invention.

### DESCRIPTION OF A PREFERRED EMBODIMENT

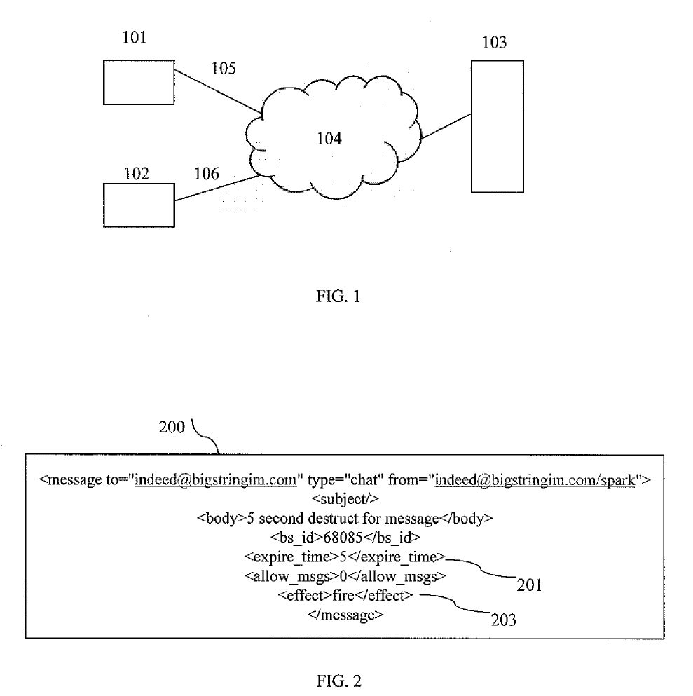

Instant messaging (IM) as described herein generally has a sender and a recipient who can exchange instant messages in real-time or in near real-time, as is known. A diagram of an IM system is provided in FIG. 1. Both a sender computing device 101 and recipient computing device 102 are connected via connections 105 and 106 to an IM server 103 via a network 104. The network 104 is usually the Internet. A computing device 101 or 102 can be a computer, such as a personal computer or a laptop computer. A computing device can also be a Personal Digital Assistant (PDA), a mobile phone or a GPS device. It can also be any device that can connect with a network and exchange information. A connection between the network and a computing device can be a wired connection, including optical cable or a wireless connection such as a radio connection.

The IM server 103, which may comprise one or more computer devices, provides the capability for computing devices 101 and 102 to exchange information, including instant messages. The basic functions of an IM server 103 are well known to one of ordinary skill in the art, and may include functions such as detecting if a user is on-line, routing of messages, and managing the transfer of messages. Generally, the IM server 103 does not provide storing and forwarding of messages, such as is applied in, for instance, transfer of emails. Some services, however, do provide some form of store and forward, but in general the storage is limited. So the instant message, or part of an instant message during texting, really may not exist as a retrievable file on the server and has to be destroyed on a client device such as the recipient's device. Computing devices 101 and 102 can each be called a client of the IM server 103.

During a transmission, when a recipient is disconnected from the network, a message sent by a sender is usually lost. The IM server 103 usually can detect that a recipient is off-line and may stop transmitting the message. The sender may be alerted that the recipient is off-line.

In general, an instant message may be considered a direct connection between two terminals. Because a message by a sender is usually composed using a screen, that message may be temporarily stored on the sending device. A message that is received by a recipient is usually displayed on a screen. It may thus be temporarily stored on the recipient device. As these messages are available in a temporary memory they may actually be saved on a computing device. It is an aspect of the present invention to destroy an instant message and make it not retrievable from either the sending device, the recipient device or both devices.

The following is a set of steps that is involved in setting up and performing instant messaging.

For IM to work on a computing device requires an IM application to be installed on the computing device. Such an application may be downloaded, for instance, from a web site and installed on the device. The application may already be an integrated part of another application such as an Internet Browser, or it may be installed as a plug-in to a browser. Such an application may also be embedded in hardware or installed as part of an operating environment of the computing device.

Activating an IM application may open a window in which text may be entered by a sender from a keyboard or a file (such as an image) may be tagged to be transmitted in the context of a real-time connection to a recipient. The window may also be used to display text which was typed by the recipient in response to the sender, or to display or play a file which was sent by the recipient to the sender in the context of a real-time connection. The terms sender and recipient are used herein in the normal meaning. They are also used to indicate who initiated the communication (the sender) and who responded to the initiation of the communication (the recipient). Because IM is generally a two-way communication, the recipient may respond to a message from the sender.

IM is usually performed in real-time or near real-time with a seemingly direct connection. This may sometimes provide the impression that the messages are fleeting and do not persist after a connection has been ended, and may lead to a false sense of privacy. However, messages do persist and can often be printed, saved, retrieved and forwarded.

Once the IM application (also called the “client”) is installed on a computing device, the user may open or activate the application and the device on which the client is installed may be connected to a server through a network. A user usually has to register at least once, so the server can identify the user when the computing device is connected to the server. The server and client work in accordance with a protocol. Such protocols are generally proprietary to a service and/or applications. Different IM services use generally different protocols and are generally not inter-operable.

Known examples of instant messaging applications and services are, for instance, those related to AOL Instant Messenger (AIM®) and Microsoft® Windows Messenger. Others are also available.

In one embodiment of an IM application, when a user activates the IM client, the details of the user's device are relayed to the server. Also, a list of contacts (known as “buddy list”) may be sent to the server. The server may then let the user know which of the users on the “buddy list” are on-line and may be contacted to successfully initiate a communication or IM session.

When a user contacts another user (usually from the “buddy list”) and initiates an IM session, ports on the devices from sender and recipient may be activated to allow real-time or instant messaging, allowing, so to speak, to make a recipient device an output device for a sender device and vice versa. The role of the server is to transport data directly from sender to recipient. No data is usually stored on the IM server.

Many users operate behind a firewall. In such cases, for instance, a “polling” type of protocol may be used.

In accordance with an aspect of the present invention, an IM messenger application is provided that will allow a message to be destroyed at the recipient's and at a sender's side. In that sense, the diagram of FIG. 1 illustrates a novel configuration as computing devices 101 and 102 are both able to create, send, receive and destroy destroyable instant messages.

While instant messaging is a well known application, there are different ways and methods of implementation. A common element between different IM applications is that they all work under a protocol, which may be specific to a type of instant messaging application and which regulates the transfer of the message over a network such as the Internet over a server between at least two parties. It may also regulate other aspects, such as a ‘buddy list’ and providing notification which party of a ‘buddy list’ is actually on-line.

As an aspect of the present invention, an instant messaging application is used to provide an instant message over a network between at least two clients, with data or an instruction that instructs a receiving client to destroy the instant message. Instant messaging usually works under a well defined protocol. Thus, the sending client application may, for instance, fill a defined part or field of a message, which may not be displayed, but will be transferred and will be received and interpreted by the receiving client. The receiving client, which according to one aspect of the present invention, has an application for reading and displaying the message, corresponding to the sending client reads and interprets the field in a received message and acts accordingly. For instance, a predefined field or part of a message may have a number. The presence of such number can be interpreted by the application at the receiving side client as the number of seconds that a message will be displayed before it will be destroyed. After the pre-set time has passed, the recipient client application then removes the message including multi-media content from display and removes all stored content from the client's memory and storage devices. Alternatively, the mere presence of a number in a field, or tag or recognizable designation can indicate an instruction that the message needs to be destroyed.

An example is shown in FIG. 2. This message is in compliance with an XMPP protocol, also known as Jabber, which is an open, XML-inspired protocol for near real time, extensible instant messaging (IM) and presence information (also known as “buddy list”). The XML field 201 between tags <expire_time> and </expire_time> shows the number 5. This means that the displayed instant message will stop being displayed after 5 seconds on the recipient's client display and that the application at the recipient client will remove or destroy the traces of this instant message from the recipient's client. Accordingly, after 5 seconds no details of the instant message will be available for viewing or retrieval. Additionally, all information including files associated with the instant message can be destroyed upon detection of the instruction.

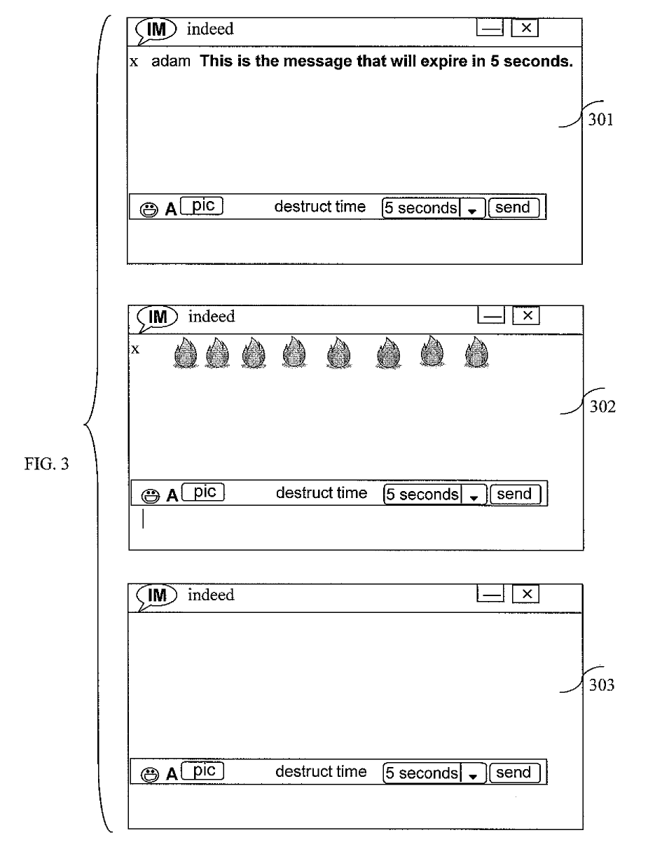

The destruction time can be set by the sender in a user interface. The destruction time cannot be changed by the recipient in the user interface. FIG. 3 shows as an illustrative example 3 images of a an instant messenger's user interface, which may be a recipient's interface. It may also be a sender's interface. In accordance with an aspect of the present invention, an interface as shown in FIG. 3 may be what both the sender and the recipient see it is an exact mirror image of each other, only distinguishable by the names of the sender and recipient. Image 301 shows a user interface with an instant message being displayed at less than 5 seconds after, for instance, receipt. Image 302 shows the instant message being destroyed at 5 seconds of display at the recipient computing device. The recipient computing device uses a visual effect of fire or flames to show removal of the instant message. Message 303 shows that after 5 seconds the message is no longer displayed.

Various visual effects can be used to illustrate the destruction of the instant message. The particular visual effect can be programmed into the instruction that is sent from the sender computing device to the recipient computing device. For example, a “1” could indicate the use of a flame effect. A “2” could indicate the use of a lightening effect. These various visual effects can be selected by a sender of an instant message in a user interface. The selection of the visual effect can occur when the instant message is sent or can be set for all instant messages at one time.

In accordance with a further aspect of the present invention, an instant messenger application is created which enables the creation and/or the filling of a field or a tag or designation in a message recognizable by an application to destroy the message.

In accordance with yet a further aspect of the present invention, an application residing at a recipient client is enabled to recognize a destruction field or tag or designation in an instant message and to destroy the message based on such a tag, field or designation. The field, tag or designation may contain a condition for destruction. Such a condition may be a time constraint. Such a time constraint may be entered by a sending user during entering of a message. Such a constraint may also be entered by the application at the sending client. Such a constraint, like a time constraint, may also be set by an application or a user at the recipient client. This allows a recipient to prevent cluttering of a device and storage of unproductive or undesirable material on the device.

If initially no destruction designation was provided to a message by a sender, the sender my send a follow up message which will immediately destroy the preceding message. Such a message will contain the appropriate references to the previous instant message, including a field, tag or designation that marks the preceding message for immediate destruction. A recipient will receive such a message and its application will destruct the relevant message. One may provide an application with a button or short-cut or menu option that when activated will automatically generate and send the destruct message to the recipient.

In accordance with a further aspect of the present invention, the sender can also destroy a message that has a time limit in an instruction before that time limit has expired. A sender may provide, for instance, an instruction to destroy the message by clicking in the user interface on the sender client on a field, or icon or any other designated destruction mark, for instance, next to a message that has been already sent. This will generate a message from the sender to the recipient that will instruct the client of the recipient to destroy the relevant message immediately, even before the initial time to destroy has expired.

As a further aspect of the present invention, the actions to the e-mail experienced on a screen by a recipient will also occur on the sender's screen. So when a message disappears at a recipient, it will also disappear from the sender's screen.

A field 203 in the message of FIG. 2, will determine for the application at the recipient client to provide a visual effect accompanying the disappearance of the message from display. In the example message of FIG. 2, an XML tag is used: <effect>fire</effect>. This instructs an instant messenger application to apply pre-programmed flames or fire effects when a message is removed or destructed. One effect is illustrated in image 302 in FIG. 3. Other visual effects such as blurring, dissolving, and exploding which may be accompanied with other effects such as sound effects may also be used. Other effects such as sound or vibratory effects not using visual effects may also be used for indicating the destruction of a message.

Computer programs that can communicate across a network are known. For instance, computer programs are known using the XMPP or Jabber protocol that can communicate in instant messaging over the Internet between sending and recipient clients and that enable the transfer and use of message fields, tags or other designations upon which a computer application can react. However, the aspects of destroying an instant message are novel.

Furthermore, a receiving client and/or a sending client may be configured to make it impossible to print, to save or to screen capture a message.

There are different possible embodiments of such features in an instant messaging application.

In one embodiment, an Adobe® Flash® Player is used. Such a player may usually be downloaded from a website. Furthermore, the recent version of Adobe® Flash® Player can be programmed with a program called Actionscript and is enabled to work with the XMPP protocol. Furthermore, Adobe® Flash® Player can fully interact with a web browser. Accordingly, such an embodiment establishes a fully Internet enabled instant messenger.

In addition, Adobe® Flash® Player enables some other aspects in accordance with the present invention.

In accordance with a further aspect of the present invention, the Adobe® Flash® Player can be programmed to prevent printing of an Adobe® Flash® Player screen. Thus, an instant messenger is created that enables display of an instant message for a limited while it is being displayed.

In accordance with yet a further aspect of the present invention, the Adobe® Flash® Player can be programmed to prevent capturing of the Adobe® Flash® Player screen by for instance a “screen print” command. Thus, a displayed message in an Adobe® Flash® Player screen cannot be captured and thus cannot be saved as a file and perhaps displayed or printed at a later stage.

In a first embodiment, the instant messenger in accordance with an aspect of the present invention is a Flash® application. A diagram of this embodiment is shown in FIG. 4. The application 401 can be downloaded, for instance, from a website and be installed on the client. The Flash® application communicates over the Internet to a recipient client 404 via server 403 over a port or socket 402. The server 403 is preferably an XMPP or Jabber server in this embodiment. The sending and receiving clients are computing devices that can display a message, communicate over a network and execute a computer application to process an instant message. A client can be a computer, or a mobile device, including a mobile phone or a Personal Digital Assistant (PDA).

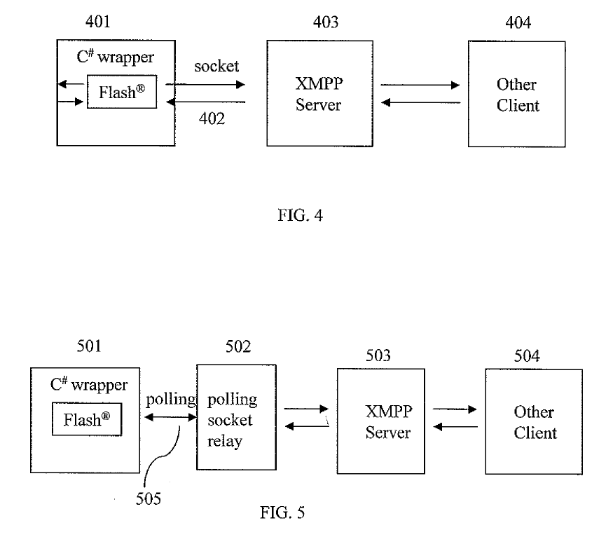

Sometimes a client is located behind a firewall and cannot actively communicate over a port or socket with the outside world through the firewall. This situation is shown in diagram in FIG. 5. In that case, the sending client 503 is connected to a polling socket relay 505 that works preferably under a “http” protocol. The connection is polled on a regular basis thus allowing transfer of messages to the server 503 to the receiving or other client 504. This allows for almost instant messaging through a firewall. The application is programmed to detect that direct communication as shown in FIG. 4 is not possible and reverts almost directly to the embodiment of FIG. 5.

It should be clear that sending client and receiving client positions may be reversed and that a sending client may also be a receiving client and a receiving client may be a sending client.

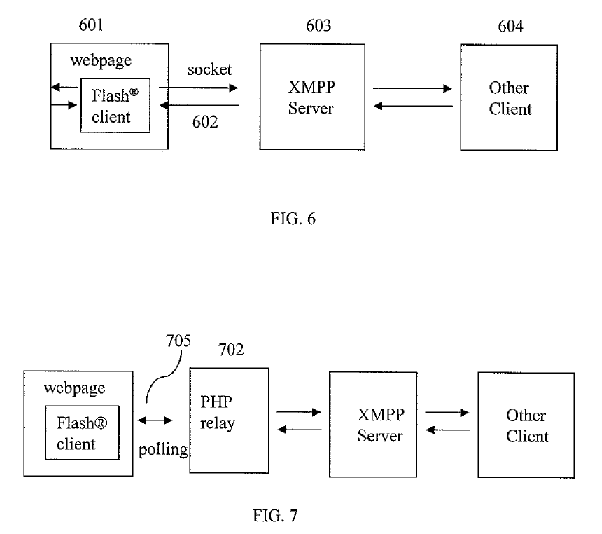

In a further embodiment, a user may not want to download and install an application. In such case a user may be connected to the XMPP server via a webpage. A diagram of an embodiment is shown in FIG. 6. Herein a user accesses a webpage as shown in 601 which enables a Flash client which works through a browser to communicate over port or socket 602 with the XMPP 603 server to communicate with a user 604 for instant messaging.

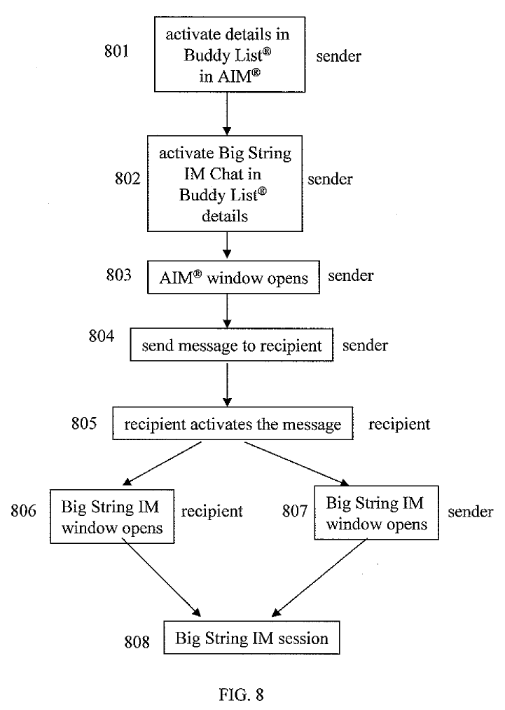

It may be that the user of the webpage is behind a firewall and cannot directly communicate with server 603. In that case the webpage reverts also to a polling mode as is shown in FIG. 7 via a PHP relay 703. Communication 705 is then preferably happening under a “http” protocol.

Accordingly, the instant messaging method and apparatus as provided herein can work in absence of a firewall but also behind a firewall or behind several firewalls.

In yet another embodiment, a user may have another instance of an instant messenger on their computing device. Many of these existing applications have a list of existing contacts. They also may have a facility that indicates which one of the existing contacts is on-line or connected and potentially available for instant messaging. In accordance with a further aspect of the present invention, an addition to an existing instant messenger also called a plug-in will be provided that allows the use of destroyable instant messages with a contact list of an existing instant messenger.

Such an existing instant messenger, as an illustrative example, may be an AOL Instant Messenger (AIM®). The AIM® usually has a contact list called a Buddy List® of known contacts associated with it. In order to keep on using the Buddy List® a user may download a plug-in that will provide the advantages of destroyable instant messages and other features described herein as well as allows continued use of the Buddy List®.

In one embodiment wherein the AOL plug-in is downloaded and installed one may start a destroyable chat or instant message by right-clicking the Buddy List®.

The process of initiating, for instance, an instant messaging session with destroyable messages is illustrated in FIG. 8. The instant message application wherein an instant message is destroyable is called BigString instant messaging or IM. An interface for such a form of instant messaging will be called a BigString interface or window or message window or IM window.

FIG. 8 shows as an example using an AOL instant messaging application (AIM®) with a BigString plug-in to start an instant messaging session with a destroyable instant message. Assume that a user with a computing device enabled to use AIM® also has installed the BigString plug-in. This plug-in will enable the user to start an instant messaging session with a destroyable instant message. In step 801, the sender activates the AIM® Buddy List®, for instance, by right-clicking an icon or symbol or name representing the Buddy List®. This may bring up a list of menu items containing at least one item being a BigString item. In step 802, by activating the BigString item, which was inserted by the plug-in, by the sender will activate an AIM® session 803 at the sender and in a step 804 a message will be sent by the sender to a contact on the Buddy List®. The contact being the recipient of the message may activate the received message in step 805, for instance, by clicking on a symbol representing the message. This will activate as step 806 at the recipient a BigString instant messaging window, enabled for destroyable instant messages. The activation of the message by the recipient will result in step 807 of the opening of a BigString window at the sender. Now both sender and receiver are enabled to exchange destroyable instant messages and in step 808 a BigString instant messaging session using destroyable instant messages can proceed.

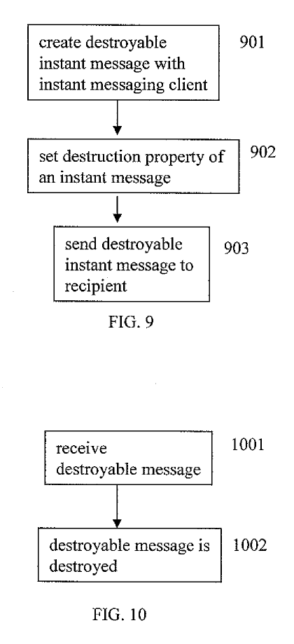

Flow diagrams illustrating different aspects of the present invention are provided in FIGS. 9, 10, 11 and 12. FIG. 9 shows how to set the destruction of an instant message by the sender. In step 901 an instant message is created by the sender. In step 902, the destruction of the instant message is set, for instance, by setting a time after which the instant message will be destroyed. In one embodiment, the instant message will be destroyed at the recipient and the sender. In step 903, the instant message is sent to the recipient. The order of steps 901 and 902 may be reversed, so that a time after which an instant message will be destroyed is set before creating an instant message. For instance, the instant messaging client may have a configuration setting that will apply to all created instant messages.

In accordance with a further aspect of the present invention, a copy of the destroyable instant message that resides on the sender's client after being sent to the recipient will also be destroyed if or when the destroyable message will be destroyed on the recipient's client. For instance, when a sender sets the time of destruction in a destroyable message to be sent to the recipient, the viewing copy of the destroyable instant message will also have an instruction to be destroyed with the same time limit as the message that is to be sent.

FIG. 10 illustrates the process of receiving and destroying an instant message by the recipient. In step 1001, the client of the recipient receives the destroyable instant message. The recipient's client detects the instruction for destruction in the received instant message. After the time set in the message has expired the recipient's client destructs in step 1002 the received destroyable instant message.

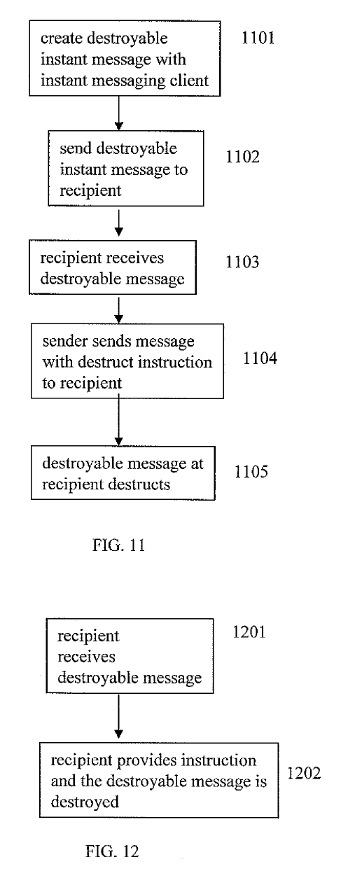

It may occur that an instant message is sent by a sender without setting an instruction for destruction of the destroyable instant message. FIG. 11 shows a diagram of how to destroy a destroyable message not having a destruct instruction after sending it to a recipient. In step 1101, a destroyable message is created, however without setting an instruction for destruction. The destroyable instant message is sent in step 1102 to the recipient who receives it in step 1103. After sending the instant message, the sender realizes that the message will not be destroyed, for instance, because the instant message persists on the sender's computing device. In step 1104, the sender sends a follow up message to the recipient related to the previous instant message comprising an instruction to destruct the previous instant message. The message with the destruct instruction is received by the recipient and the previous instant message is destructed.

FIG. 12 illustrates yet another aspect of the present invention, which is to destroy a destroyable instant message by the recipient. It is possible that a sender does not set an instruction for a destroyable instant message to be destroyed. It may also be the case that a recipient does not want any instant message to persist on the recipient client or the recipient computing device. In FIG. 12, a recipient receives a destroyable message in step 1201. The recipient notices that the destroyable message is not destructed after a certain time and in step 1202 provides an instruction for a destroyable instant message that was received to be destroyed. An instruction may be provided for all destroyable instant messages to be destructed. An instruction may also be provided to destruct a certain type of destroyable instant messages, for instance, ones that have existed on the client for longer than a certain time. A recipient may also provide a configuration setting that will destroy a destroyable instant message when it has been displayed on the client for longer than a pre-set time. Other criteria for destruction, such as sender, type of message such as text or image and other criteria are fully contemplated.

The terms destroyable messages and destructing of messages is used herein. A message is constituted by a plurality of digital symbols, usually bit of series of bits that in their context of a message or a frame or any other relevant context create a displayable message on a computing device. The displayable message may be text formed from characters for instance. The displayable message may also be an image. The displayable message may also be video. The displayable message may also be a sound. The displayable message may be of any form that can be recognized or interpreted by a person. The display of a message by a computing device is a means relevant to the display of the message. For instance, a display may be a screen that displays text characters. It may be a screen that displays images or video. A display may be a means to produce sound, or any other display relevant to a message. In general, a message is received and temporarily stored in a memory on a computing device from which it will be retrieved and processed to be displayed on a relevant display. Once the message is no longer available in a memory or a storage medium it can no longer be displayed by the computing device. The destroying or destructing of a destroyable message on a computing device is thus rendering unusable for display the message in the memory of the computing device. Such a destroying of a message may take several forms. It may be overwriting the memory containing the message partly or entirely with new data. It may be to deliberately overwrite important information to retrieve a message or any other means or method that makes retrieving of the message from memory impossible. By making retrieving of a message impossible it can no longer be displayed and the message has effectively been destroyed.

As one aspect of the present invention, a destroyable instant message is provided. As another aspect of the present invention a computing device is provided that can be used as a client to be connected through a network to a server to another client for conducting instant messaging with destroyable instant messages. As a further aspect, a system is provided for instant messaging using destroyable instant messages. Such a system comprises at least a sending client, a receiving client and a network that connects the two clients. A client is a computing device having means to store instructions and/or data, retrieve instructions and/or data and processing means to execute the instructions and/or data. Such processing means can be a processor such as a micro-processor. However, such means can also be custom built and/or programmed circuitry. A processing means can be a dedicated circuit wherein instructions are embedded and no further programming may be required.

A computing device can be a mobile device. The network may comprise mobile connections or wired connections or a combination of a wired and a wireless connection. The system for instant messaging using destroyable instant messages may also have at least one server that is connected with the two clients. The two clients and the server may all be in different locations. The network that connects the at least two clients and the at least one server may be an Internet.

While there have been shown, described and pointed out fundamental novel features of the invention as applied to preferred embodiments thereof, it will be understood that various omissions and substitutions and changes in the form and details of the methods, devices and systems illustrated and in its operation may be made by those skilled in the art without departing from the spirit of the invention. It is the intention, therefore, to be limited only as indicated by the scope of the claims appended hereto.

1. A method for automatic destruction of an instant message in a computing device, comprising:
providing a capability in the computing device to destroy an instant message based on an instruction;
receiving and detecting the instruction to destroy the instant message at the computing device; and
the computing device destroying the instant messaging based on detection of the instruction.

2. The method as claimed in claim 1, further comprising including in the instruction a time after which the instance message will be destructed, wherein the computing device destroys the instant message in accordance with the time.

3. The method as claimed in claim 1, wherein the instruction is part of the instant message.

4. The method as claimed in claim 1, wherein the instruction is sent to the computing device after the instant message was sent.

5. The method as claimed in claim 1, wherein the computing device is selected from the group consisting of: a computer, a mobile computing device, a mobile phone, and a GPS device.

6. The method as claimed in claim 1, further comprising connecting the computing device to an Internet, wherein the instant message and the instruction are received via the Internet.

7. The method as claimed in claim 1, further comprising loading a plug-in to an existing instant messaging client for instant messaging on the computing device, the plug-in being capable of destroying instant messages upon receipt of the instruction.

8. The method as claimed in claim 1, wherein the instant message cannot be printed

9. The method as claimed in claim 1, wherein the instant message cannot be retrievably saved on the computing device.

10. The method as claimed in claim 1, further comprising:
destroying a copy of the instant message on a sending computing device that transmitted the instant message by an instruction originating from the sending computing device.

11. The method as claimed in claim 1, further comprising displaying a visual effect when destroying the instant message.

12. The method as claimed in claim 11, further comprising a sender of the instant message selecting the visual effect to be used when destroying the instant message.

13. A computing device for instant messaging, comprising:
a processor;
a memory for storing data;
a software client loaded on the computing device which causes the processor to:
receive and display an instant message;
detect and execute an instruction; and
destroy the instant message in accordance with the instruction.

14. The computing device for instant messaging as claimed in claim 13, wherein the instant message is destroyed after a pre-set time specified in the instruction.

15. The computing device for instant messaging as claimed in claim 13, wherein the instant message cannot be printed.

16. The computing device for instant messaging as claimed in claim 13, wherein the computing device is selected from the group consisting of: a personal computer, a laptop computer, a mobile phone, and a GPS device.

17. A system for instant messaging, comprising:
a server;
a network;
at least two client computing devices connected to the server through the network;
wherein a first of the client computing devices has a processor enabled to execute instructions to perform the steps of:
sending an instant message;
sending an instruction associated with the instant message to destroy the instant message;
wherein a second of the client computing devices has a processor enabled to execute instruction to perform the steps of:
receiving and detecting the instruction to destruct the instant message; and
destroying the instant message on the first client device based on detection of the instant message.

18. The system for instant messaging as claimed in claim 17, further comprising the instruction having a specified time in which the instance message is destroyed.

19. The system for instant messaging as claimed in claim 17, wherein the network is an Internet.

20. The system for instant messaging as claimed in claim 17, wherein the first and second client computing devices are selected from the group consisting of: a personal computer, a laptop computer, a mobile phone, and a GPS device.

21. The system for instant messaging as claimed in claim 17, wherein the destroyable message cannot be saved.

22. The system for instant messaging as claimed in claim 17, wherein the destroyable message cannot be printed.
